(19) United States
(12) Patent Application Publication
(10) Pub. No.: US 2026/0118836 A1
(43) Pub. Date: Apr. 30, 2026

(54) METHODS AND SYSTEMS FOR DISCRETE EVENT SUMMARY AND FORECASTING USING LARGE LANGUAGE MODELS

(71) Applicant: Robert Bosch GmbH, Stuttgart (DE)

(72) Inventor: HyeongSik KIM, San Jose, CA (US)

(21) Appl. No.: 18/928,961

(22) Filed: Oct. 28, 2024

(51) Int. Cl. G05B 13/02

(52) U.S. Cl. CPC G05B 13/0265

(57) ABSTRACT

Methods and systems for predicting operational events in a manufacturing environment using Large Language Models LLMs. The methods and systems involve receiving sensor data from multiple sensors at various stations, indicative of machine parameters. A n anomaly detection engine analyzes this data to identify anomalies. Metadata related to operational interruptions is recorded. Users input prompts via an interface, accessing historical event data, anomalies, and metadata. Prompts are enriched with historical data, outputs from a Pattern Knowledge Graph, and predictions of future anomalies. The LLM processes these enriched prompts to generate initial outputs, predicting future anomalies or significant events, enhancing decision-making and reducing manual intervention.

### TECHNICAL FIELD

The present disclosure relates to methods and systems for discrete event summary and forecasting using large language models. In embodiments, these methods and systems are used for semantic pattern summary and prediction in manufacturing environments.

### BACKGROUND

Recent advancements in artificial intelligence have led to the development of models capable of handling complex tasks, utilizing deep learning architectures to process and generate human-like text. Despite their capabilities, these models often face challenges when applied outside their immediate domain, leading to inaccuracies. Techniques have been explored to enhance performance by integrating information retrieval methods, allowing dynamic access to external databases for more accurate responses.

The application of these models in predicting discrete events, particularly in specialized fields like manufacturing, remains extremely limited. While some modern manufacturing facilities employ advanced event monitoring systems to capture anomalies and issue alerts, these systems require manual assessment to determine the need for intervention, as anomalies do not lead to operational interruptions.

### BRIEF DESCRIPTION OF THE DRAWINGS

FIG. 1 shows a system for training a neural network, according to an embodiment.

FIG. 2 illustrates a general schematic of a work line in a manufacturing facility 200, according to an embodiment.

FIG. 3A is a schematic of one embodiment of a system configured to utilize Large Language Models (LLMs) to interpret the current status and forecast potential future events in manufacturing environments.

FIG. 3B is a time sequence of detected anomalies and predicting future interruptions according to an embodiment.

FIG. 4 is an embodiment of a computing platform for implementing the neural network algorithms and/or methodologies described herein.

FIG. 5 is a method for predicting operational events within a manufacturing environment using LLMs, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Large Language Models (LLMs) have become pivotal in addressing complex question-answering tasks, adeptly selecting appropriate responses from a vast array of potential answers. LLMs, such as OpenAI's GPT series, are based on deep learning architectures called transformers, which enable them to process and generate human-like text by learning patterns and relationships within large datasets. Despite their success, LLMs frequently encounter challenges when operating outside their immediate domain of expertise, leading to errors or “hallucinations,” which include incorrect information generated by the model. To address these shortcomings, techniques such as Retrieval-Augmented Generation (RAG) have been explored. RAG combines the generative capabilities of LLMs with information retrieval methods, allowing the model to dynamically access external databases during the generation process to provide more accurate and contextually relevant responses.

However, the application of LLMs in predicting discrete events, particularly in specialized fields such as manufacturing, remains under-explored. Manufacturing environments face significant challenges in predicting operational events due to the complexity and variability of machine parameters. Traditional systems often rely on manual monitoring and intervention, which can lead to inefficiencies and increased downtime. The need for advanced predictive analytics has become necessary to enhance decision-making processes and maintain operational continuity. Modern manufacturing facilities have utilized sophisticated event monitoring and recording systems like Anomaly Detection Engines (ADE). These systems capture anomalies as temporal events and issue alerts to domain experts as a preemptive measure against potential critical incidents. Despite these advancements, the occurrence of anomalies does not consistently result in operational interruptions, necessitating a manual assessment to determine the need for intervention. Also, reliance on manual evaluation can be slow and difficult, leading to delays and inaccuracies in addressing potential issues in the manufacturing facility, highlighting the limitations of current technologies in autonomously predicting and managing operational disruptions. This gap highlights a crucial need for advanced models that can autonomously explain the current status and forecast operational interruptions, thereby enhancing the decision-making process and reducing reliance on manual evaluations.

Therefore, according to various embodiments herein, methods and systems are disclosed herein for leveraging LLMs to predict operational events within a manufacturing environment. By employing a zero-shot methodology, the system utilizes detailed prompts enriched with historical event patterns and metadata. This approach enables the LLMs to generate accurate event summaries and predictions without prior specific training on the data. The system introduces a dual-query framework, allowing domain experts to quickly ascertain the current operational status and predict future events, thereby enhancing operational decision-making and reducing manual intervention.

In embodiments, the methods and systems leverage LLMs equipped with a set of potential future events, derived from historical data using frequent event pattern mining techniques. The methods and systems disclosed herein can enhance this dataset with additional meta-information, including actual event patterns and metadata concerning event frequency and duration. This enriched input enables LLMs to discern and select the most plausible future events based on a deep semantic understanding of the event context. The disclosed systems yield a significant capability in accurately predicting future operational interruptions, thereby streamlining the decision-making processes in real-time manufacturing environments. This novel application of LLMs in the field of discrete event prediction not only extends the utility of language models but also presents a significant advancement in predictive analytics, particularly in the automation of complex industrial operations.

In evaluating a manufacturing process using an LLM, according to embodiments, deep neural networks (DNNs) can form the foundation, enabling the model to understand and analyze complex patterns in manufacturing data. The core architecture can involve Transformers, which excel at processing and learning from sequences, allowing the model to identify trends in time-series data, such as detecting potential interruptions in production or determining whether manufactured parts meet specifications. In some cases, convolutional neural networks (CNNs) might be used to analyze visual data, like images of parts for quality control, extracting local features for precise analysis. Additionally, graph neural networks (GNNs) can be incorporated if the manufacturing process involves relationships between components or machinery that can be represented as interconnected systems. This combination of neural networks allows the LLM to provide accurate evaluations and insights, ensuring manufacturing processes run smoothly and output meets quality standards.

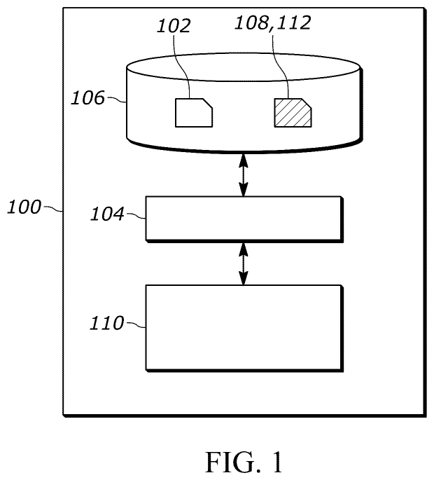

Since the disclosed systems and methods rely on machine learning models such as neural networks (e.g., DNNs, GNNs), deep convolutional networks (DCN), CNN,) and the like, it may be helpful to describe the use and training of such systems. FIG. 1 shows a system 100 for training a neural network, e.g., a graphical neural network, that can be used in the machine-learning models described herein. The neural networks illustrated and described herein merely examples of the types of machine learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input the output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

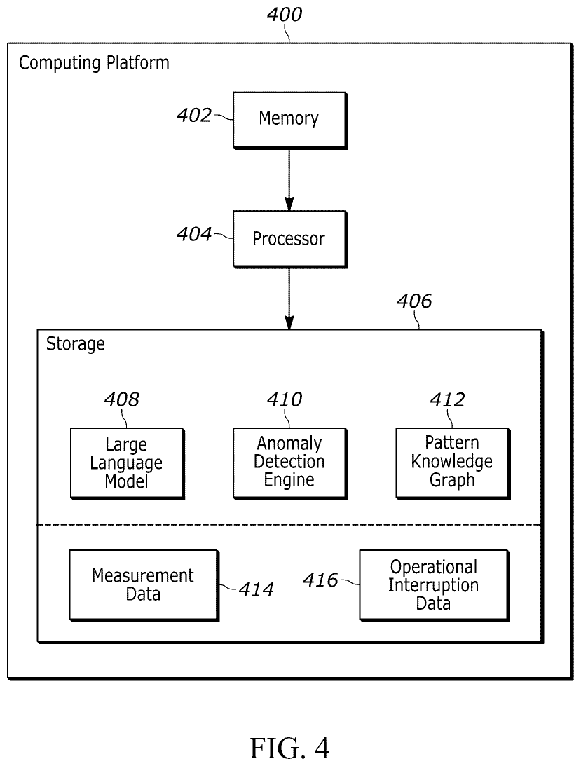

The structure of the system 100 is one example of a system that may be utilized to train the neural networks described herein. Additional structure for operating and training the machine learning models is shown in FIG. 4, described later.

Regarding manufacturing processes, a final product may go through several work stations before the part is completely finished or manufactured. For example, before a final product is produced, it may first need to be assembled with other sub-components, painted, laser etched, strength tested, or other manufacturing tasks. After each station completes its tasks, measurements may be taken of the part to produce measurement data. This makes sure the part is sufficiently operational, sufficiently connected, sufficiently sized, etc. Measurement data may include which type of station the measurement is taken, which type of part is being measured, and what is the measurement. The measurement can be a binary value, a strength value, a time series value (e.g., a measurement of the response to pressure), floating precision number, number string, integer, Boolean, aggregation of statistics, or the like which represents a physical state or characteristic of the part. This measurement data can be multimodal (e.g., may include multiple types of measurements, such as those listed above as an example). This multimodal measurement data may be input into a neural network described herein. Depending on the measurements taken at the station, the system can determine if the part is sufficient, or instead should be binned or discarded. This measurement data can also be referred to as (or part of) sensor data. The sensor data can be received from one or more sensors at a plurality of stations of a manufacturing facility, wherein the sensor data is indicative of machine parameters associated with machines located at the stations.

This multimodal measurement data inputted in a machine-learning model (e.g., neural network, GNN, LLM) can yield various benefits and can yield a plethora of information that can help manufacturing lead time and logistics. For example, the output of the neural network can yield predictions as to whether the parts will be sufficient for production or assembly into another system, predictions as to whether stations are going to be needed to be offline, predicting yield time, as well as predictions as to where a failure may have occurred along the manufacturing line, why the failure occurred, and the like. In another example, the output of the neural network can yield predicted measurements at any station along the manufacturing line; given this information, one can remove a station (or procedure within that station) devoted to measuring the component being manufactured. This can save time and money in measuring.

Also, predictive measurements of the manufactured part along the manufacturing line can reduce costs associated with scrapping a component. If a measurement of a component can be estimated within the manufacturing line (e.g., at or between every manufacturing station), this can lead to a more precise determination of when a failure or misstep in manufacturing takes place. This can mean scrapping a component earlier in the manufacturing process before it becomes more expensive to do so. Also, depending on when a component is actually measured along the manufacturing process, predicting the measurement of a component before the component is actually measured allows the component to be scrapped earlier in the manufacturing process.

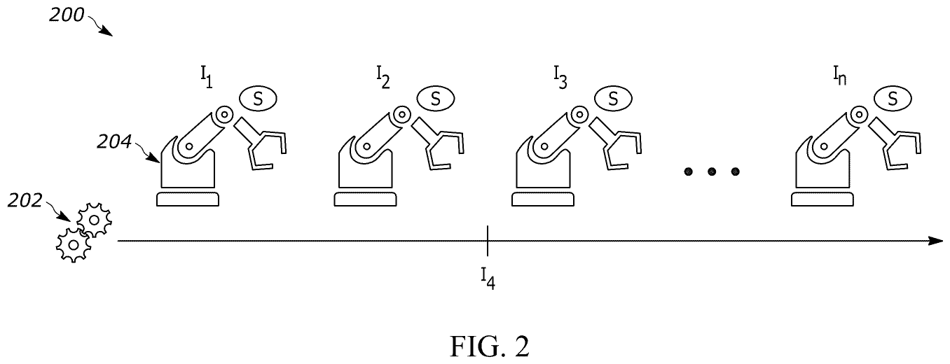

FIG. 2 illustrates a general schematic of a work line in a manufacturing facility 200, according to an embodiment. Here, a component 202 is manufactured, at least in part. The component 202 can be any type of component subject to manufacturing processes, and the present disclosure is not limited to any particular type of component. It can be a vehicle, a part of a vehicle, a gear, toothpaste containers, soap, food items, etc.

The component or part 202 can travel through the work line, being worked upon by a variety of machines 204. Each machine is located at a defined location (11, 12, 13 . . . . In). Each machine also has a sensor (labeled “s”) that is configured to sense data, as will be described herein, and produce measurement data. Other locations (e.g., 14) can be defined along the work line, and these locations can also have their own sensors configured to produce measurement data. The sensors need not be equipped on a particular machine, but can be capable of generating measurement data at any defined location along the work line.

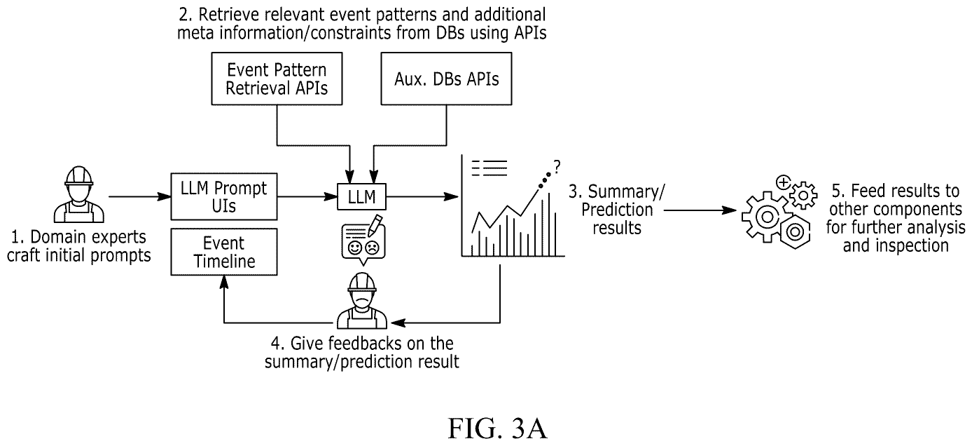

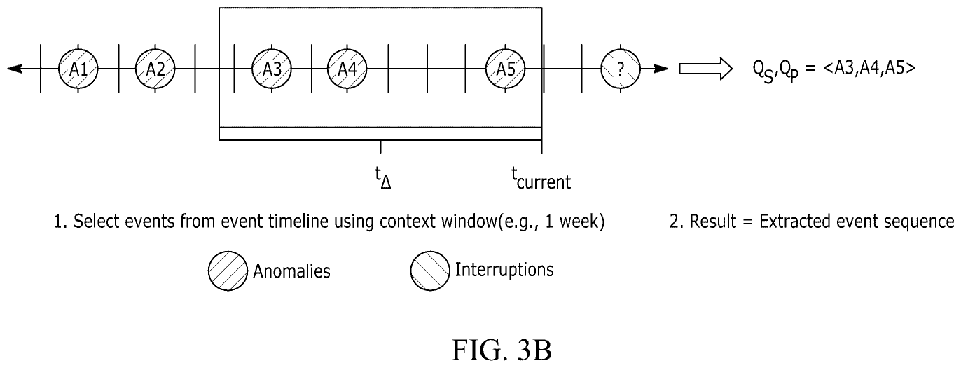

FIG. 3A is a schematic of one embodiment of a system 300 configured to utilize LLMs to interpret the current status and forecast potential future events in manufacturing environments. Additional detail of such a system is described further throughout, but in general, the process initiates when domain experts employ user interfaces equipped with pre-built templates or steps to compose preliminary prompts. The user interfaces can be implemented in the form of, for example, a tablet, a computer, a smart phone, or the like. Concurrently, these interfaces access historical event data from event pattern databases and other relevant sources via application programming interfaces (APIs), incorporating comprehensive domain knowledge. After the domain experts finalize the prompts and submit their requests, the interface forwards these prompts to the LLMs. The LLMs then process the requests and generate results. Based on these initial outcomes, experts may refine the prompts to improve the accuracy and relevance of the LLM outputs. This iterative cycle of prompt crafting and review persists as needed, enabling experts to accurately assess the current state of the manufacturing processes and make well-informed predictions about future events. Additionally, the outputs from the LLMs can be integrated into other analytical tools or machine learning models for further analysis or to inspect specific stations along the manufacturing lines.

The forthcoming descriptions will provide a more detailed description and overview of the concepts along with associated terminologies used in this report. Following this foundational introduction, we will delve into the specific embodiments and elaborate on the algorithms and methodologies employed at each stage.

First, some foundational definitions are provided. These words defined below are not intended to be limited to just these definitions. Rather, these definitions are intended to give more context to these words.
Definition 1: Location. Let L={l₁, l₂, l₃, . . . lₙ} be a set of locations within a production line, where each location lᵢ is uniquely identified by a location ID. The location ID can be a spatial and temporal coordinate, for example.

To ensure the integrity of the manufacturing process, monitoring systems such as the Anomaly Detection Engine (ADE) continuously monitor these readings from the locations in real time. These systems are often designed to incorporate predefined rules to detect various types of anomalous events, including outliers, sudden changes in mean or variance, gradual mean shifts, and an increase in zero values. Anomalies detected are recorded in a real-time database. Non-critical anomalies may not immediately affect production, but critical ones could indicate underlying faults in the machinery that potentially lead to production interruptions. These interruptions can be recorded by a separate system, thus distinguishing them from the anomalies tracked by these monitoring systems.
Definition 2: Event. Let E=A∪I be the set of all events of interest within the system, where A represents the set of anomalies and/the set of interruptions. Each event e∈E is characterized by a tuple (t, l, . . . ), where t represents the timestamp and I∈L the location of the event.
Definition 3: Anomaly. An anomaly a∈A is a special type of event characterized by a tuple (t, l, p, τ, α), with p denoting the measured parameter, τ the detection technique, and α the anomaly level.
Definition 4: Interruption. An interruption i∈I is characterized by a tuple (t, l, d, ι, h), where d denotes the duration, ι the type of interruption, and h a human-input text describing the interruption. Data associated with the interruption can be stored as operational interruption data 416.

Each recording of these events is important for domain experts to manage potential disruptions. Each of these events can be detected and recorded using the ADE 410, for example. However, continuously displaying each event and alerting users often results in manual tracking and analysis, which could counteract the ADE's goal of reducing user burdens. To mitigate this, the concept of the Pattern Knowledge Graph (PKG) is introduced. By constructing event sequences from individual events within specific periods and summarizing these sequences as graphs, domain experts can easily track significant events and identify correlations between anomalies and interruptions. In this disclosure, some parts of the PKG construction pipelines are leveraged for constructing event sequences, employing similar methodologies and components. Here, each sequence is defined to begin with an anomaly and includes subsequent events up to and including the interruptions within a specified time range. This time range can be any customized or defined time range, but can be, for example, one week but can be adjusted as necessary.

Before the event sequences are defined, it is important to introduce the concept of an event identifier. This identifier simplifies the complex nested structures and metadata commonly found in manufacturing systems into alphanumeric codes that pattern mining algorithms can process.
Definition 5: Event Identifier. An event identifier is a unique alphanumeric code used to label and distinguish different types of operational events. Each identifier consists of a letter prefix and a numerical suffix, where the prefix indicates the event type (“A” for anomalies and “I” for interruptions) and the suffix is a unique number assigned sequentially. Anomalies “A” can be detected via execution of the ADE 410, and data associated with the interruptions can be stored as operational interruption data 416.
Definition 6: Event Identifier Mapping. Let M be a mapping function from event identifiers to their semantic meanings. Each event e∈E is associated with an identifier idₑ and a semantic meaning M(idₑ), which describes the specific characteristics or the domain-specific interpretation of the event. This mapping is defined as M:IDs-->Descriptions, where IDs is the set of all possible event identifiers and Descriptions is the set of detailed explanations provided by domain experts.

For example, for an anomaly event identifier with A1160, the mapping function M(A1160) can return the description “Needle.Force+Outlier”, indicating a significant deviation in needle force measurement.

Utilizing event identifiers, event sequences can now be formally defined.
Definition 7: Positive and Negative Event Sequences. An event sequence S=<e₁, e₂, . . . , eₖ> is defined as before, where each e₁∈E and i∈j implies that eᵢ occurred before eⱼ. Two categories of event sequences are introduced. A positive event sequence ends with one or more subsequent interruptions. For example, if Sₚₒₛ=<a₁, a₂, i₁, i₂>, where a₁ and a₂ are anomalies and i₁ and i₂ are subsequent interruptions, Sₚₒₛ is considered positive because it ends with a sequence of interruptions <i₁, i₂> without any intervening anomalies. In contrast, a negative event sequence does not end with a sequence of interruptions. For example, if S_{neg}=<a₁, a₂, a₄>, where all elements are anomalies, S_{neg} is negative as it concludes without any interruptions.

The rationale for categorizing event sequences based on the presence of interruptions is to discern which anomalies potentially contribute to operational disruptions. This distinction is crucial for informing domain experts who analyze the sequences to identify critical points of failure and for guiding remedial actions. Additionally, providing this categorized data to LLMs enables them to generate more accurate summaries and predictions. Interventions signify a reset in the operation of corresponding lines or locations, often marking a return to a baseline or ‘clean state’. Thus, interruptions serve as natural delimiters in a continuous event stream, allowing the separation of events into coherent sequences that effectively reflect operational realities and facilitate predictive analytics.

Having constructed the event sequences, extracting patterns will be described. As done for constructing PKGs, PrefixSpan algorithm can be employed for mining the most prevalent subsequence patterns from our sequences, although alternative algorithms or libraries are equally applicable for identifying frequent event patterns. The process culminates in the formal introduction of event patterns, described below.
Definition 8: Positive and Negative Event Patterns. An event pattern P is a subsequence of an event sequence that satisfies specific frequency criteria within the dataset, highlighting its significance or predictive power. There are two types of event patterns: a positive event pattern and a negative event pattern. A positive event pattern, for instance <a₁, a₂, i₁>, originates from a series of positive event sequences where a particular sequence of anomalies consistently precedes interruptions. A negative event pattern, such as <a₁, a₃>, emerges from negative event sequences, characterizing a sequence of anomalies that does not culminate in an interruption.

The pattern mining process can be performed by the pattern knowledge graph 412 and might identify subsequences that do not end with an interruption from positive event sequences; for example, from two positive event sequences: <a₁, a₂, i₁>, and =<a₁, a₂, a₃, i₁>, the miner could deduce=<a₁, a₂>, as a valid event pattern, despite it not concluding with an interruption. Although this contradicts the traditional definition of a positive event pattern, recognizing these patterns may still provide valuable insights for domain experts and LLMs. It is crucial to offer flexibility in the classification of these patterns. Users (domain experts) can decide whether to strictly categorize such patterns as negative or to consider them as genuine positive instances, depending on their significance in the specific domain or application.

In the final output, the mining algorithm generates a set of tuples, each consisting of the frequency of an event pattern and the pattern itself, represented as a list. The frequency indicates the number of sequences in which the pattern appears. These patterns are stored in a dedicated database, termed the pattern database, which can utilize standard database systems like MySQL or MongoDB. For example, assuming that MongoDB is used, its database setup then can include a collection named “xyz_event_sequence” and another named “xyz_event_pattern”. The role of these collections is to store event sequences and patterns specific to a certain product or component called ‘xyz’ in manufacturing plants. Within these collections, we maintain fields for event sequence and pattern data, as well as metadata such as location ids (i.e., where the event sequence was observed) and the timestamps marking the start and end of an event. Furthermore, we also indicate whether the event sequences and patterns are positive or negative. It is also feasible to maintain two completely independent tables/collections for positive and negative patterns, enhancing data organization and retrieval efficiency. These event sequences and patterns are indexed for efficient retrieval using one or two specific events as keys. The mechanisms for querying and retrieving relevant event patterns are detailed in the subsequent subsection ‘Retrieving Relevant Event Patterns’.

Prompts that users can construct and submit to the LLMs for direct forecasts or for generating codes aimed at analysis and predictions can be designed and formulated in different ways. In one embodiment, initially, the LLMs require a comprehensive understanding of the operational context within the manufacturing plant. This includes an overview of station-specific scenarios, derived from historical data collected from manufacturing equipment. Such contextual groundwork is critical for enabling accurate predictive outputs. For example, the prompt can be: “The below records are the historical frequent patterns I collected from some manufacturing machines that produce the high-pressure injectors and high-pressure pump.”

Similar to instructing a human, it is important for LLMs to grasp the terminologies and structural concepts associated with event identifiers and their sequences. For clarity, a user can define the format of these sequences explicitly, such as: “Each line in the data represents a pattern, where the first identifier, e_current, denotes the current event and the second, e_subsequent, indicates the potential subsequent event. The list encapsulates historical occurrences where these identifiers are observed.”

To facilitate comprehension by the LLM, concrete examples can be provided. For example: “Consider the current event identified as e_current=A1368 and the subsequent event as e_subsequent=A1168. Historical patterns might include (e_current, e_subsequent) along with a series of other events such as <A1234, A1364, A1368, A1163, I128>, <A1368, A1163, A480, I51, I73, I128>>. In these identifiers, those beginning with ‘A’ denote anomalies or precursors, whereas those starting with ‘I’ represent interruptions that ideally should be preempted.”

In this structured description, e_current and e_subsequent are utilized to denote the specific event identifiers within the sequence, reflecting their roles as either ongoing or forthcoming events, respectively. Events starting with ‘A’ and ‘I’ are interpreted according to Definitions 3 and 4 as anomalies and interruptions. This format not only aids in the precise understanding of the event sequences but also in their analytical treatment in predictive models.

Historical event patterns can be cataloged. This process involves compiling a list of detailed historical patterns of event sequences observed at specified locations within a manufacturing environment. For example, consider a current event identifier as e_current=A1368, with potential future events denoted as e_1=A1163, E_2=I97, and e_3=A1165, each followed by respective event sequences. These sequences can be cataloged in the format (e_{current}, eᵢ, [S₁, S₂, . . . ]), where Sⱼ represents a list of events forming a historical pattern. A prompt can be entered, for example as follows:

We have 12 historical patterns below so far:
A1368 A1163<<A1234, A1364, A1163, 1128>, <A1368, A1163, A480, I51, I73, I128>>A1368 A1165<<A1160, A1159, A481, A1368, I97>>A1368, A1165<<A1160, A1159, A1364, A1158, A1160, A1159, A1159, A1372, A2085, A481 A481, A4368, A1165, A2222M A1344, I90>>

Here, each pattern is a subsequence of event sequences that satisfy certain frequency criteria within the dataset, categorizing them into positive or negative event patterns based on their composition, as defined in Definitions 5 and 6. These patterns help the LLMs to recognize historical event sequences and predict potential future events based on this data. The data format can vary, including simple delimited formats like space-separated values or more structured formats such as JSON and YAML, depending on the complexity required.

Detailed descriptions of event types can be provided. This involves providing additional descriptions and categorizations of event types so that the LLMs can have understanding or interpretations on event sequences we provided. Specifically, we provide additional information on event type using event identifier mapping defined in the definition 6 as follows. We also additionally provide additional descriptions on terminologies used in the semantic meanings so that LLMs can have better understanding on the idea or meaning of each event. Due to space limitations, only few example records are listed below:

In Addition, what these events ids mean is as follows, e.g., A1160 means the case where its parameter name is Needle. Force+Outlier, meaning that it monitors the outlier of the needle force. Some descriptions are Turkish.

```
A1160 Needle. Force + Outlier
A1159 Needle. Force + MeanShift
A1158 Needle. Force + Bunching
A1160 Needle. Force + Outlier
...
I90 2500 (Presleme)
I97 2614 (Robot Haberle me ar zas)
I11 1299 (Fifostrecke Voll)
I126 2950 (Kalite Problemi)
I51 220 (Storung Mechanik)
...
Additionally:
  Trends: Steep Slope, Trending to tolerance, Gradual increase in
  NOK, ...
  Outlier: Extreme values, Drift invariant outlier, Non-Guassian
  outlier, ...
```

Requests can then be constructed. This component concentrates on constructing queries, which can be categorized into two types: (i) Status Queries that prompt LLMs to summarize event sequences and inform experts of the current status, and (ii) Predictive Queries that utilize sequences of current events to predict future patterns. While it is feasible to pose these queries simultaneously, querying them separately tends to yield more reliable and thorough recommendations.

Status requests on current event sequences calls for LLMs to provide a concise summary of specified event sequences, informing users of the essential ongoing activities. The LLMs are tasked with interpolating descriptions tied to events within these sequences and offering their synthesized analysis.
Definition 7: Status Query. Let S={s₁, s₂, . . . sₙ}, be a sequence of events, where each event sᵢ is associated with certain attributes and metadata. The Status Query function Qₛ is a function defined as Qₛ: P(S)→Summary, where P(S) denotes the power set of S, representing all possible sub-sequences of events within S.

The function Qₛ can operate by (1) analyzing the frequency and patterns of occurrences of each event identifier within S, (2) interpolating descriptions and synthesizing an analysis based on the attributes and metadata tied to these events, and (3) producing a summary that highlights significant patterns, anomalies, and potential areas for action.

For example, Consider the sequence S=<A1160; A1159; A1364; A1158; A1160; A1159; A1372; A2085; A481; A481; A1368>. The Status Query function Qs processes these events to identify and summarize the prevailing patterns and anomalies in the data. For instance, the identifiers ‘A1160’ and ‘A1159’ appear multiple times, indicating repeated issues related to ‘Needle.Force’ with ‘Outlier’ and ‘MeanShift’ phenomena respectively. The function Qs synthesizes this information and provides a summary as follows: “The summary indicates a high frequency of force-related outliers and mean shifts in the needle assembly process, coupled with consistent trends in press-in window operations and compensation mechanisms, suggesting areas needing immediate inspection and potential re-calibration.”

Following the theoretical exposition of the Status Query function Qs, below is an example prompt used to engage an LLM in summarizing event sequences from a manufacturing process. This practical example incorporates additional constraints to limit the scope of the LLM's response, addressing common challenges where LLMs might otherwise provide overly comprehensive descriptions not required by the users.

Now having gathered the temporal event sequence from the manufacturing process: <1160, A1159, A1364, A1158, A1160, A1159, A1372, A2085, A481, A481, A1268>, I require a summary of the current situation. Based on these events sequences, please interpret the event sequence and offer your analysis. It is crucial not to delve into an event-by-event breakdown or explain each event individually; rather, focus on synthesizing the overall semantics of these events. Please limit your summary to no more than 100 words.

This prompt is designed to elicit a concise and integrated summary that reflects the aggregate understanding of the event sequences, while preventing the granularity that often accompanies unbounded LLM responses. Initially, the LLM provides a comprehensive overview of the situation, based on the event sequences. It then also informs users about the prevalent issues and suggests potential corrective actions.

Forecast requests based on current event sequences can be generated. This request type directs LLMs to analyze and summarize sequences of events, enabling them to forecast imminent outcomes. For instance, consider a scenario where the LLM is prompted to predict the top five most likely outcomes based on provided event sequences. Users can specify the methodologies to be employed; for example, they may instruct the LLM not to rely on frequency-based counting approaches—which assume that the most frequent events are likely to recur—but instead to focus on understanding the semantics and potential implications of these sequences. This method utilizes the LLM's capability to interpret complex event patterns and relationships, thus facilitating predictions that go beyond simple frequency analysis. Such an approach is especially beneficial in situations where the accuracy of predictions relies more on the nuanced semantics of the events than on their frequency of occurrence. The process of leveraging semantic analysis for predictive purposes in LLMs can be formally defined as follows.
Definition 7: Predictive Query. A predictive query is formulated as a function Qₚ:Sₚ→Pₚ, where Sₚ represents the space of observed event sequences and Pₚ denotes the set of possible prediction. The query function Qₚ is designed to interpret the semantic relationships within elements Sₚ to propose predictions in Pₚ.
Definition 8: Semantic Analysis. Semantic analysis in the context of event patterns refers to the process of extracting meaningful insights from the sequences of events, beyond statistical occurrences. It involves interpreting the significance of event sequences and understanding their potential impacts on future outcomes.

As an example, consider event sequence S=<A1160, A1159, A1364, A1158, A1160, A1159, A1372, A2085, A481, A481, A1368>. The predictive query function Qₚ could analyze this sequence to predict the most likely next events. Here, Pₚ could include predictions such as <A1161, A1158, A1369, A1373, A2086>, representing possible next events based on a semantic understanding of the historical patterns. The function Qₚ refrains from using a frequency-based approach, instead focusing on the implications and correlations revealed through the semantic analysis of the events in S.

Given these definitions, predictive queries can be structured to not only hypothesize the next events but also to understand the potential alternative outcomes, thus providing a comprehensive foresight into the possible future scenarios. The final part of the prompt that include the example query can be described in this way, for example:

Finally, I just collected the temporal event sequence from the manufacturing process: <A1160, A1159, A1364, A1158, A1160, A1159, A1372, A2085, A481, A481, A1368>. Considering all these historical patterns, which ones would be the most likely next event? Pick top-5 and let me know your opinion. Please do not use frequency-based approach but see if you can seriously understand the meaning of these events and let us know your opinion. If some other events would not happen right after this sequence, what else events could occur soon? Please let us your opinion:

The LLM can produce a list of the most plausible events and identifies those requiring further consideration. In the discussed example, five events are listed by the LLM as the next likely events: A1163, A480, A1364, 190, A1165. It is observed that the actual subsequent event was A1165, followed by the interruption 190, demonstrating the LLM's accurate forecasting capabilities. It is also observed that the specificity of the output may vary depending on the LLMs utilized and the user-defined settings. Typically, LLMs generate a list of potential subsequent events, contextualized with relational insights, enabling domain experts to evaluate these predictions and make informed decisions regarding probable future events.

Another remaining challenge in this study is the effective extraction of relevant event sequences or patterns that can be utilized as part of the analysis prompts. To address this, we consider two distinct cases based on the database or setups employed within the system. The first case involves the use of vector databases, where event patterns are stored in the form of vectors and common similarity metrics, such as cosine similarity, are applied to retrieve relevant event sequences. However, most vector databases or embedding techniques do not preserve event sequences in a lossless manner. Consequently, while partial retrieval of relevant events is feasible, it is highly improbable to recover complete event sequences from vector embeddings for prompt construction. This limitation renders this approach less effective. The alternative approach utilizes explicit, symbolic representations of event patterns, stored in conventional relational databases or graph file formats. This method ensures better preservation and retrieval of event sequences but still necessitates efficient indexing methods to retrieve all relevant patterns collectively. The operation of retrieving all relevant subsequent events from the stored patterns is formalized, facilitating a nuanced analysis of event relationships based on historical data. This operation can be customized to return only the most frequent subsequences and can be filtered to include only positive or both positive and negative event sequences, depending on the analytical requirements.
Definition 9: Event Pattern Retrieval. Let EP denote the set of all event patterns stored in our database. Given a source event e₂∈E, the operation of event pattern retrieval identifies all pairs (eₛ; eₙ) where eₙ is the next event following eₙ in any event pattern sequence in EP. A resulting triple is defined as (eₛ; eₙ; EPS), where EPS corresponds to the sequence containing (eₛ; eₙ). These triples can be ordered by the frequency of occurrence, with the ability to select the top-k frequent pairs, and filter to include only positive or both positive and negative event sequences as specified.

For example, consider the following set of event patterns stored as EP, which includes the following sequence:

EP={<A1234, A1364, A1368, A1163, I128>; <A1368, A1163, A480, I51,
I73, I128>; <A479, A1567, A481, A1368, I97>; <..., A1368, A1165,
A2222, A1344, I90>}

Suppose A1368 is selected as the source event. Following this selection, the event pattern retrieval operation identifies three subsequent events, each leading to different sequences. The results are presented as a set of triples indicating the source event, the next event, and the corresponding sequences in which these pairs occur.

The system also introduces an auxiliary operation designed to augment the system by facilitating the extraction of detailed metadata associated with transitions between events. This includes time intervals and their distributions within the dataset. Incorporating such metadata into the prompts for LLMs can enhance the specificity of the event descriptions provided. Our observations suggest that including this detailed information improves the accuracy of the model's summary and predictions.
Definition 10: Event Sequence Metadata Retrieval. This operation is defined for any pair of events (eₛ; eₙ), where it accesses the associated metadata stored in the database. The retrieved metadata comprises statistical summaries, which include the minimum, maximum, and average time intervals between the cited events, along with the frequency of their occurrence. This process is aimed at delivering comprehensive temporal and quantitative insights concerning the event pairs, thereby augmenting the analytical capabilities available to LLMs. The following example illustrates the type of metadata that can be retrieved. Considering two anomalies, A1368 and A1163, the operation yields a tuple as shown below. This tuple indicates that the minimum time interval recorded was 10 seconds, the maximum was 5324 seconds, the average interval was 3015 seconds, and the events occurred together twice: 1: (A1368; A1163; 10; 5324; 3015; 2; :::)

While this example highlights four specific metadata items, additional data regarding these event pairs can be stored and retrieved as required.

The disclosed system empowers domain experts by providing pre-designed templates for prompt construction. These templates ensure rapid development and maintain consistency and accuracy across queries, adhering to the guidelines outlined in the section ‘Prompt Structure’. Depending on the type of the query, not all parts of the prompt section might be needed, e.g., Status Queries would not need the catalogues of historical patterns all the time.

Domain experts are presented with a chronologically ordered list of events from which they select relevant entries to incorporate into prompts. Event sequences specified in queries can be automatically compiled in a semi-automatic fashion. To explain this process, let E be the set of all events in the timeline, where each event e∈E has an associated timestamp time (e). Define t_{current} as the current timestamp. The concept of a context window, denoted as t_{δ}, corresponds to the duration where relevant events are considered. The operation to select events within this context window can be defined as:

$$W ( E , t ) = \{ e ∈ E \vert t - t δ \leq time ( e ) \leq t \}$$

where t_{δ}=7 days, and W selects events from the set E where each event e has a timestamp within the context window ending at time t, assuming time (e) and t are measured in days. Initially, domain experts specify the range of events to be analyzed using the W operation, e.g., selecting a one-week period from a specific location's event timeline involves applying W (E, t_{current}), where anomalies and interruptions are chronologically listed. The user interface then transcribes the event ids from the timeline and populates the prompt accordingly. Consider an example timeline in FIG. 3B where events A1, A2, A3, A4, A5 occur, with time(A3), time(A4), and time(A5) falling within the one-week context window defined by W (E, t_{current}). In this scenario, only A3, A4, A5 are returned by the operation, producing Qₛ or Qₚ, while A1 and A2 are outside the context window and are not selected.

The selection and population process can be fully automated; for example, the interface may continuously retrieve streamed events from manufacturing lines and ADE, display them on a timeline, automatically select events up to one week using W, and forward the prompts to the LLMs, thus continuously updating and displaying predictive results beneath the timeline. It is important to note that while the system automates the construction of most fields, domain experts maintain the flexibility to make final adjustments prior to submission. These adjustments might include specifying decision-making authority to the LLM or requesting the generation of code templates for enhanced analysis and prediction. Although we present natural texts as example outputs in this report for readability, in actual implementations, data formats such as JSON and YAML to support interoperability, enabling other systems or components to easily ingest or display them as required.

Moreover, all prompts constructed adhere to the token limitations of the employed LLMs, such as the 4 k and 16 k token limits inherent to the GPT-3.5 Turbo system. To navigate these restrictions, the system employs strategies such as prioritizing the inclusion of historical events based on their frequency, ensuring that the most pertinent information is featured within the given constraints.

It should be understood that although the primary application of this system is within manufacturing environments utilizing temporal event data from manufacturing plants, the methodologies and systems described are sufficiently versatile to be adapted for other domains. Potential applications include predicting future events in sports, patient monitoring, analyzing driving logs from autonomous driving systems, and more, all of which leverage time-series data from various sources.

Therefore, the present disclosure includes developments in an innovative method that utilizes LLMs to summarize and predict operational events within manufacturing settings. This method significantly leverages enriched datasets comprising potential future events, meticulously extracted through techniques such as frequent event pattern mining from historical data. This approach allows for a more nuanced understanding and anticipation of operational scenarios, greatly enhancing decision making capabilities in manufacturing processes.

Moreover, the approach of the present disclosure distinguishes itself by prioritizing semantic analysis over traditional statistical frequency methods for evaluating event sequences. This shift to a deeper, meaning-based analysis facilitates more accurate predictions of future events by understanding the implications and interrelationships within event sequences, rather than merely their occurrence frequency. This methodology not only increases the accuracy of predictions but also provides richer insights into the operational dynamics of manufacturing systems.

Additionally, the present disclosure has systematically designed and integrated a robust framework capable of retrieving, selecting, and utilizing relevant event patterns effectively. This system enhances the functionality of LLMs by enabling precise selection and incorporation of event data into prompts based on an event timeline. The integration of this system supports continuous improvement in the operational intelligence of manufacturing processes, ensuring that each decision is informed by the most relevant and recent data.

The neural network algorithms and/or methodologies of one or more embodiments described herein are implemented using a computing platform, such as the computing platform 400 illustrated in FIG. 4. The computing platform 400 may include memory 402, processor 404, and non-volatile storage 406. The processor 404 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 402. The memory 402 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 406 may include one or more persistent data storage devices such as a hard drive, optical drive, tape drive, non-volatile solid state device, cloud storage or any other device capable of persistently storing information.

The processor 404 may be configured to read into memory 402 and execute computer-executable instructions residing in embedding model 408 of the non-volatile storage 406 and embodying embedding algorithms and/or methodologies of one or more embodiments disclosed herein. The processor 404 may be further configured to read into memory 402 and execute computer-executable instructions residing in dynamics model 410 of the non-volatile storage 406 and embodying dynamics algorithms and/or methodologies described herein. The processor 404 may be further configured to read into memory 402 and execute computer-executable instructions residing in prediction model 412 of the non-volatile storage 406 and embodying prediction algorithms and/or methodologies described herein. The models 408-412 may include operating systems and applications. The models 408-412 may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by the processor 404, the computer-executable instructions of the models 408-412 may cause the computing platform 400 to implement one or more of the neural network algorithms and/or methodologies disclosed herein. The non-volatile storage 406 may also include sensor data or measurement data 414 and operational interruption data 416 representing recorded metadata regarding, for example, the frequencies and durations of the operational interruption. Such data can also include, for example, an identification of the part and identification of the station where the interruption occurred, the position of different components, angles between the components, applied forces to the components, and pressures applied to the components. The measurement data 414 can include data captured or taken from a sensor located at a particular station in the manufacturing process. The measurement data 414 can also be linked or tied to the specific locations (l₁, l₂, . . . lₙ) within the manufacturing facility. The sensor may be an image sensor, laser measurement sensor, or any other type of sensor configured to yield data representing a physical quality, state, or characteristic of the part being measured.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

As a simple example, the processor 404 may access instructions stored in memory 402 to execute one or more of the LLM 408, ADE 410, and/or PKG 412 using the various data discussed herein, such as measurement data 414 and operational interruption data 416. Execution of these models can, for example, output a predicted future potential anomaly in the manufacturing facility.

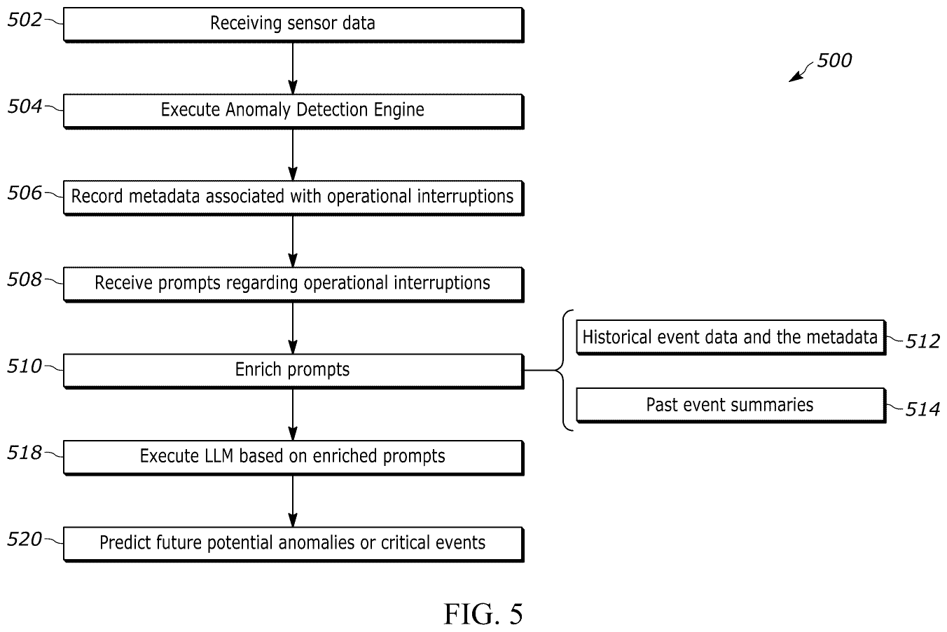

FIG. 5 illustrates a method for predicting operational events within a manufacturing environment using Large Language Models (LLMs), according to one embodiment. This method can be performed via the computing platform 400 described above, for example by the processor 404 executing instructions stored in memory to perform the steps of the method.

At 502, first, the method begins with receiving sensor data from a network of sensors distributed across various stations in a manufacturing facility. These sensors can be strategically placed to monitor critical machine parameters such as component positions, angles, forces, and pressures, etc. For example, a sensor might measure the force applied by a robotic arm or the pressure within a hydraulic system. This data is crucial for maintaining operational integrity, as it provides real-time insights into the performance and health of the machinery. This can be stored as measurement data 414. By continuously collecting this data, the system can establish a baseline of normal operations, against which anomalies can be detected.

At 504, once the sensor data is collected, an anomaly detection engine (ADE) 410 is executed to analyze the data for any irregularities. The ADE is designed to identify various types of anomalies, such as outliers, sudden changes in mean or variance, and gradual shifts. For instance, if a sensor detects a sudden spike in temperature that deviates from the norm, the ADE will flag this as an anomaly. This can involve training the model to understand what is “normal” operation, e.g., sensor data that falls within established minimum and maximum boundaries/thresholds based on typical operation, and then data that falls outside of those boundaries/thresholds would trigger the model to flag those as anomalies. These anomalies are recorded as temporal events, allowing the system to alert domain experts to potential issues before they escalate into critical incidents. This proactive approach helps in minimizing downtime and maintaining smooth operations.

At 506, the method then involves recording metadata associated with operational interruptions. This metadata includes details such as the frequency and duration of interruptions, which are essential for understanding the impact of anomalies on production. For example, if a machine frequently stops due to overheating, the metadata will capture how often and for how long these interruptions occur. This information can be stored as operational interruption data 416. By distinguishing between anomalies and actual interruptions, the system provides a clearer picture of the operational challenges, enabling more informed decision-making.

At 508, the system receives prompts input by a user via a user interface regarding the operational interruptions. The user interface is equipped with access to historical event data, which includes the sensor data, recorded anomalies, and metadata. This interface allows domain experts to craft detailed prompts that guide the system in analyzing and predicting future events. For example, a user might input a prompt to investigate the cause of frequent machine stoppages, using historical data to identify patterns or trends.

At 510, the prompts are enriched by one or more of the following: historical event data and the metadata at 512, summaries of past events at 514, and/or predictions about future potential anomalies. The event summaries of past anomalies can be output from a Pattern Knowledge Graph (PKG) 412, for example. The PKG is constructed from the metadata and recorded anomalies, providing event summaries of past anomalies. For instance, the PKG might reveal that a specific sequence of anomalies often precedes a machine failure. This enriched input enables the system to generate more accurate and contextually relevant predictions, enhancing the decision-making process.

At 518, the Large Language Model (LLM) 408 is executed based on the enriched prompts to generate initial outputs. The LLM processes the detailed prompts, leveraging its deep learning capabilities to interpret the data and provide insights into potential future events. For example, the LLM might predict that a certain anomaly pattern is likely to lead to a machine breakdown, allowing for preemptive maintenance actions. This step is crucial for transforming raw data into actionable intelligence.

Finally, at 520, the method involves predicting future potential anomalies or critical events in the manufacturing facility based on the execution of the LLM with the enriched prompts. By utilizing the LLM's predictive capabilities, the system can forecast operational disruptions, allowing for timely interventions and minimizing downtime. For instance, if the LLM predicts a high likelihood of a machine failure, maintenance can be scheduled proactively to prevent production delays. This predictive analytics approach enhances decision-making processes and improves operational efficacy within the manufacturing environment.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for predicting operational events within a manufacturing environment using Large Language Models (LLMs), the method comprising:
receiving sensor data from a plurality of sensors at a plurality of stations of a manufacturing facility, wherein the sensor data is indicative of machine parameters associated with machines located at the stations;
executing an anomaly detection engine (ADE) on the sensor data to monitor and record anomalies in the machine parameters;
recording metadata associated with operational interruptions in the manufacturing facility;
receiving, via a user interface, prompts input by a user regarding the operational interruptions, wherein the user interface includes access to historical event data, wherein the historical event data is associated with or includes the sensor data, the recorded anomalies, and the metadata;
enriching the prompts based on historical event data and the metadata associated with the operational interruptions;
executing the LLM based on the enriched prompts to generate initial outputs; and
predicting future potential anomalies or critical events in the manufacturing facility based on the execution of the LLM with the enriched prompts.

2. The method of claim 1, wherein the enriching the prompts is further based on predictions about future potential anomalies without prior specific training on the historical event data.

3. The method of claim 1, wherein the enriching the prompts is further based on outputs from a Pattern Knowledge Graph (PKG) that is constructed from the metadata associated with the operational interruptions and the recorded anomalies, wherein the outputs from the PKG include past interruption event summaries.

4. The method of claim 1, further comprising:
presenting the initial outputs from the LLMs to the user via the user interface;
iteratively refining the prompts based on feedback from the user to enhance precision and relevance of the initial outputs; and
executing the LLM based on the refined prompts to generate (i) updated event summaries of past events, and (ii) updated predictions about future potential anomalies.

5. The method of claim 1, wherein the recorded metadata includes frequencies and durations of the operational interruptions.

6. The method of claim 1, wherein the ADE is configured to detect the anomalies based on utilizing predefined minimum and maximum thresholds for detecting outliers, sudden changes in mean or variance, or gradual mean shifts in the sensor data.

7. The method of claim 1, wherein the recording metadata includes frequency and duration of interruptions associated with a location within the manufacturing environment.

8. The method of claim 1, further comprising:
providing the initial outputs to a verification system that (i) verifies whether the initial outputs are correct, or (ii) verifies existence of one or more of the operational interruptions.

9. A system for predicting operational events within a manufacturing environment using Large Language Models (LLMs), the system comprising:
a processor; and
memory storing instructions that, when executed by the processor, cause the processor to perform the following steps:
receiving sensor data from a plurality of sensors at a plurality of stations of a manufacturing facility, wherein the sensor data is indicative of machine parameters associated with machines located at the stations;
executing an anomaly detection engine (ADE) on the sensor data to monitor and record anomalies in the machine parameters;
recording metadata associated with operational interruptions in the manufacturing facility;
receiving, via a user interface, prompts input by a user regarding the operational interruptions, wherein the user interface includes access to historical event data, wherein the historical event data is associated with or includes the sensor data, the recorded anomalies, and the metadata;
enriching the prompts based on historical event data and the metadata associated with the operational interruptions;
executing the LLM based on the enriched prompts to generate initial outputs; and
predicting future potential anomalies or critical events in the manufacturing facility based on the execution of the LLM with the enriched prompts.

10. The system of claim 9, wherein the enriching the prompts is further based on predictions about future potential anomalies without prior specific training on the historical event data.

11. The system of claim 9, wherein the enriching the prompts is further based on outputs from a Pattern Knowledge Graph (PKG) that is constructed from the metadata associated with the operational interruptions and the recorded anomalies, wherein the outputs from the PKG include past interruption event summaries.

12. The system of claim 9, wherein the instructions, when executed by the processor, further cause the processor to perform:
presenting the initial outputs from the LLMs to the user via the user interface;
iteratively refining the prompts based on feedback from the user to enhance precision and relevance of the initial outputs; and
executing the LLM based on the refined prompts to generate (i) updated event summaries of past events, and (ii) updated predictions about future potential anomalies.

13. The system of claim 9, wherein the recorded metadata includes frequencies and durations of the operational interruptions.

14. The system of claim 9, wherein the ADE is configured to detect the anomalies based on utilizing predefined minimum and maximum thresholds for detecting outliers, sudden changes in mean or variance, or gradual mean shifts in the sensor data.

15. The system of claim 9, wherein the recording metadata includes frequency and duration of interruptions associated with a location within the manufacturing environment.

16. The system of claim 9, wherein the instructions, when executed by the processor, further cause the processor to perform:
providing the initial outputs to a verification system that (i) verifies whether the initial outputs are correct, or (ii) verifies existence of one or more of the operational interruptions.

17. A non-transitory computer-readable storage medium comprising instructions that, when executed by a processor, cause the processor to perform the following:
receiving sensor data from a plurality of sensors at a plurality of stations of a manufacturing facility, wherein the sensor data is indicative of machine parameters associated with machines located at the stations;
executing an anomaly detection engine (ADE) on the sensor data to monitor and record anomalies in the machine parameters;
recording metadata associated with operational interruptions in the manufacturing facility;
receiving, via a user interface, prompts input by a user regarding the operational interruptions, wherein the user interface includes access to historical event data, wherein the historical event data is associated with or includes the sensor data, the recorded anomalies, and the metadata;
enriching the prompts based on historical event data and the metadata associated with the operational interruptions;
executing the LLM based on the enriched prompts to generate initial outputs; and
predicting future potential anomalies or critical events in the manufacturing facility based on the execution of the LLM with the enriched prompts.

18. The non-transitory computer-readable storage medium of claim 17,
wherein the enriching the prompts is further based on predictions about future potential anomalies without prior specific training on the historical event data.

19. The non-transitory computer-readable storage medium of claim 17,
wherein the enriching the prompts is further based on outputs from a Pattern Knowledge Graph (PKG) that is constructed from the metadata associated with the operational interruptions and the recorded anomalies, wherein the outputs from the PKG include past interruption event summaries.

20. The non-transitory computer-readable storage medium of claim 17, wherein the instructions, when executed by the processor, cause the processor to perform:
presenting the initial outputs from the LLMs to the user via the user interface;
iteratively refining the prompts based on feedback from the user to enhance precision and relevance of the initial outputs; and
executing the LLM based on the refined prompts to generate (i) updated event summaries of past events, and (ii) updated predictions about future potential anomalies.
